(19) United States
(12) Patent Application Publication
(10) Pub. No.: US 2009/0262464 A1
(43) Pub. Date: Oct. 22, 2009

(54) PERPENDICULAR MAGNETIC WRITE HEAD HAVING A WRAP AROUND SHIELD CONSTRUCTED OF A LOW PERMEABILITY MATERIAL FOR REDUCED ADJACENT TRACK ERASURE

(76) Inventors: Hardayal Singh Gill, Palo Alto, CA (US); Wen-Chien David Hsiao, San Jose, CA (US)

Correspondence Address: ZILKA-KOTAB, PC- HIT, P.O. BOX 721120, SAN JOSE, CA, 95172-1120, US

(21) Appl. No.: 12/106,941

(22) Filed: Apr. 21, 2008

(51) Int. Cl. G11B 5/127

(52) U.S. Cl. 360/319

(57) ABSTRACT

A magnetic write head for perpendicular magnetic recording having a trailing, wrap around magnetic shield constructed of a low magnetic permeability. The lower permeability of the shield prevents magnetic saturation of the shield, which in turn prevents adjacent track interference such as adjacent track erasure. The shield can also be constructed as a pure trailing shield, or as first and second side shields without any trailing shield portion.

### FIELD OF THE INVENTION

The present invention relates to perpendicular magnetic recording and more particularly to magnetic write head having a wrap-around magnetic shield that is constructed of a low permeability material for reducing adjacent track interference.

### BACKGROUND OF THE INVENTION

The heart of a computer's long term memory is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located on a slider that has an air bearing surface (ABS). The suspension arm biases the slider toward the surface of the disk, and when the disk rotates, air adjacent to the disk moves along with the surface of the disk. The slider flies over the surface of the disk on a cushion of this moving air. When the slider rides on the air bearing, the write and read heads are employed for writing magnetic transitions to and reading magnetic transitions from the rotating disk. The read and write heads are connected to processing circuitry that operates according to a computer program to implement the writing and reading functions.

The write head has traditionally included a coil layer embedded in first, second and third insulation layers (insulation stack), the insulation stack being sandwiched between first and second pole piece layers. A gap is formed between the first and second pole piece layers by a gap layer at an air bearing surface (ABS) of the write head and the pole piece layers are connected at a back gap. Current conducted to the coil layer induces a magnetic flux in the pole pieces which causes a magnetic field to fringe out at a write gap at the ABS for the purpose of writing the aforementioned magnetic transitions in tracks on the moving media, such as in circular tracks on the aforementioned rotating disk.

In recent read head designs, a GMR or TMR sensor has been employed for sensing magnetic fields from the rotating magnetic disk. The sensor includes a nonmagnetic conductive layer, or barrier layer, sandwiched between first and second ferromagnetic layers, referred to as a pinned layer and a free layer. First and second leads are connected to the sensor for conducting a sense current therethrough. The magnetization of the pinned layer is pinned perpendicular to the air bearing surface (ABS) and the magnetic moment of the free layer is located parallel to the ABS, but free to rotate in response to external magnetic fields. The magnetization of the pinned layer is typically pinned by exchange coupling with an antiferromagnetic layer.

The thickness of the spacer layer is chosen to be less than the mean free path of conduction electrons through the sensor. With this arrangement, a portion of the conduction electrons is scattered by the interfaces of the spacer layer with each of the pinned and free layers. When the magnetizations of the pinned and free layers are parallel with respect to one another, scattering is minimal and when the magnetizations of the pinned and free layer are antiparallel, scattering is maximized. Changes in scattering alter the resistance of the spin valve sensor in proportion to cos Θ, where Θ is the angle between the magnetizations of the pinned and free layers. In a read mode the resistance of the spin valve sensor changes proportionally to the magnitudes of the magnetic fields from the rotating disk. When a sense current is conducted through the spin valve sensor, resistance changes cause potential changes that are detected and processed as playback signals.

In order to meet the ever increasing demand for improved data rate and data capacity, researchers have recently been focusing their efforts on the development of perpendicular recording systems. A traditional longitudinal recording system, such as one that incorporates the write head described above, stores data as magnetic bits oriented longitudinally along a track in the plane of the surface of the magnetic disk. This longitudinal data bit is recorded by a fringing field that forms between the pair of magnetic poles separated by a write gap.

A perpendicular recording system, by contrast, records data as magnetizations oriented perpendicular to the plane of the magnetic disk. The magnetic disk has a magnetically soft underlayer covered by a thin magnetically hard top layer. The perpendicular write head has a write pole with a very small cross section and a return pole having a much larger cross section. A strong, highly concentrated magnetic field emits from the write pole in a direction perpendicular to the magnetic disk surface, magnetizing the magnetically hard top layer. The resulting magnetic flux then travels through the soft underlayer, returning to the return pole where it is sufficiently spread out and weak that it will not erase the signal recorded by the write pole when it passes back through the magnetically hard top layer on its way back to the return pole.

### SUMMARY OF THE INVENTION

The present invention provides a magnetic write head having a magnetic write pole having an end disposed toward an air bearing surface, the magnetic write pole having first and second laterally opposed sides and a trailing edge extending from the first side to the second side. The write head also includes a trailing, wrap-around magnetic shield that is constructed of a magnetic material having a low magnetic permeability (low μ).

The low permeability (low μ) of the shield prevents adjacent track interference (such as adjacent track erasure) by preventing the magnetic saturation of the shield during use. While it had previously been believed that low permeability materials could not be used in such shield (because it was believed that coercivity must be kept low), it has been found that low permeability materials can be effectively used in such shields with little or no affect on write field strength or field gradient.

In addition to a trailing, wrap-around trailing shield, the invention can also be embodied in a pure trailing shield with no side shield portions, or as side shields with no trailing shield.

The shield can be constructed of a material such as CoFeCr, CoFeP, CoFeCu or CoFeB, which have been found to provide the desired lower permeability while also maintaining acceptably low coercivity.

These and other features and advantages of the invention will be apparent upon reading of the following detailed description of preferred embodiments taken in conjunction with the Figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider, taken from line 2-2 of FIG. 1, illustrating the location of a magnetic head thereon;

FIG. 3 is a cross sectional view of a magnetic head, taken from line 3-3 of FIG. 2 and rotated 90 degrees counterclockwise, of a magnetic write head according to an embodiment of the present invention; and

FIG. 4 is an ABS view of the magnetic head of FIG. 3, as viewed from line 4-4 of FIG. 3.

### DETAILED DESCRIPTION OF THE EMBODIMENTS

The following description is of the best embodiments presently contemplated for carrying out this invention. This description is made for the purpose of illustrating the general principles of this invention and is not meant to limit the inventive concepts claimed herein.

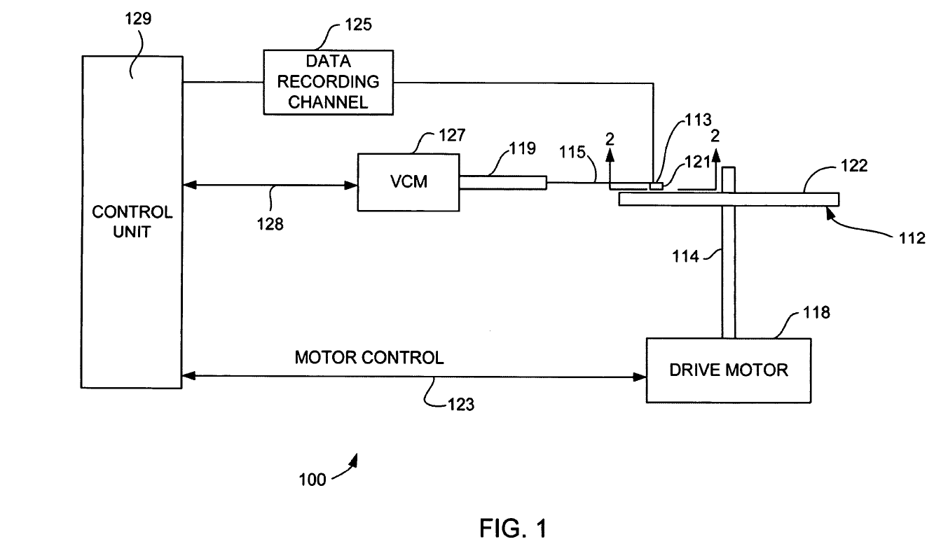

Referring now to FIG. 1, there is shown a disk drive 100 embodying this invention. As shown in FIG. 1, at least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves radially in and out over the disk surface 122 so that the magnetic head assembly 121 may access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 off and slightly above the disk surface by a small, substantially constant spacing during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

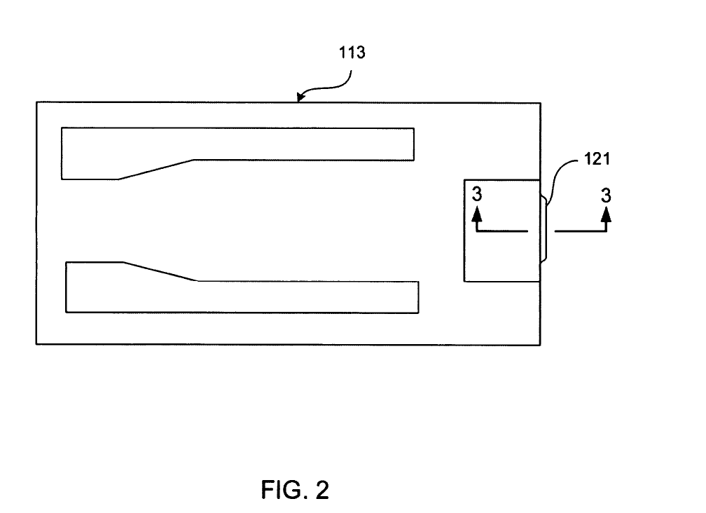

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system, and the accompanying illustration of FIG. 1 are for representation purposes only. It should be apparent that disk storage systems may contain a large number of disks and actuators, and each actuator may support a number of sliders.

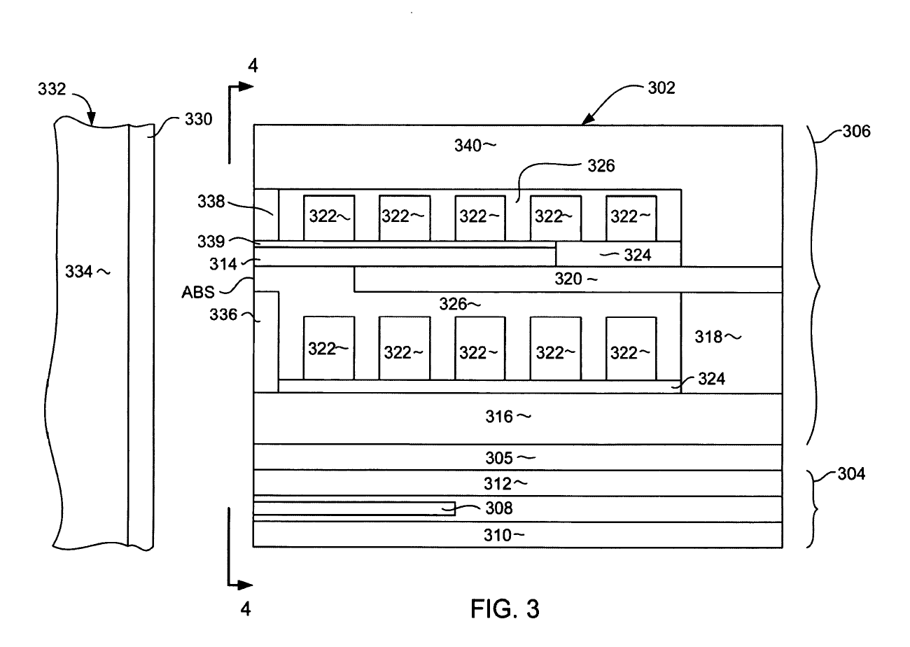

With reference now to FIG. 3, the invention can be embodied in a magnetic head 302. The magnetic head 302 includes a read head 304 and a write head 306. The read head 304, and write head 306 can be separated from one another by a non-magnetic, electrically insulating fill layer 305, such as alumina. The read head 304 includes a magnetoresistive sensor 308, which can be a GMR, TMR, or some other type of sensor. The magnetoresistive sensor 308 is located between first and second magnetic shields 310, 312.

The write head 306 includes a magnetic write pole 314 and a magnetic return pole 316. The write pole 314 can be formed upon a magnetic shaping layer 320, and a magnetic back gap layer 318 magnetically connects the write pole 314 and shaping layer 320 with the return pole 316 in a region removed from the air bearing surface (ABS). A write coil 322 (shown in cross section in FIG. 3) passes between the write pole and shaping layer 314, 320 and the return pole 316, and may also pass above the write pole 314 and shaping layer 320. The write coil can be a helical coil or can be one or more pancake coils. The write coil 322 can be formed upon an insulation layer 324 and can be embedded in a coil insulation layer 326 such as alumina and or hard baked photoresist.

In operation, when an electrical current flows through the write coil 322. A resulting magnetic field causes a magnetic flux to flow through the return pole 316, back gap 318, shaping layer 320 and write pole 314. This causes a magnetic write field to be emitted from the tip of the write pole 314 toward a magnetic medium 332. The write pole 314 has a cross section at the ABS that is much smaller than the cross section of the return pole 316 at the ABS. Therefore, the magnetic field emitting from the write pole 314 is sufficiently dense and strong that it can write a data bit to a magnetically hard top layer 330 of the magnetic medium 332. The magnetic flux then flows through a magnetically softer under-layer 334, and returns back to the return pole 316, where it is sufficiently spread out and week that it does not erase the data bit recorded by the write head 314. A magnetic pedestal 336 can be provided at the ABS, and attached to the leading return pole 316 to act as a magnetic shield to prevent stray field from the write coil 322 from inadvertently reaching the magnetic media 332.

In order to increase write field gradient, and therefore, increase die speed with which the write head 306 can write data, a trailing, magnetic shield 338 can be provided. The trailing, magnetic shield 338 is separated from the write pole by a non-magnetic write gap 339, and may be connected with the shaping layer 320 and/or back gap 318 by a trailing return pole 340. The trailing shield 338 attracts the magnetic field from the write pole 314, which slightly cants the angle of the magnetic field emitting from the write pole 314. This canting of the write field increases the speed with which write field polarity can be switched by increasing the field gradient. The non-magnetic trailing gap layer 339 can be constructed of a material such as Rh, Ir or Ta.

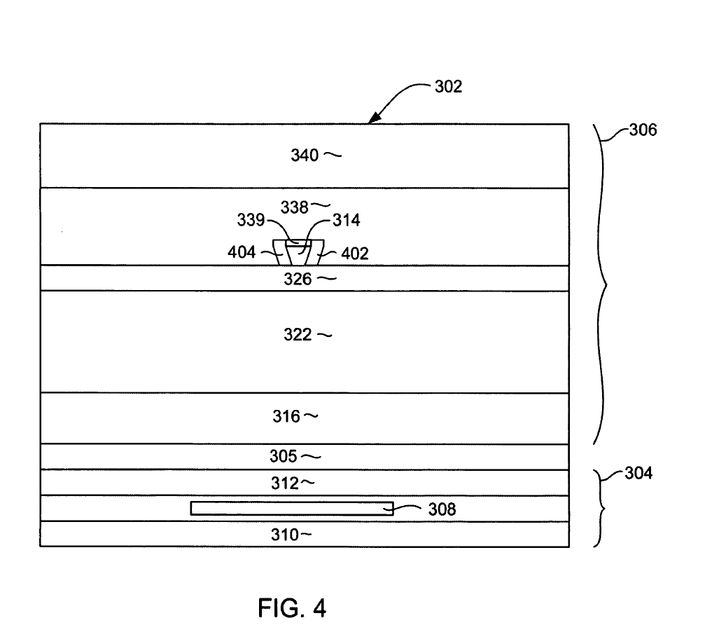

FIG. 4 shows a view of the head 302 as viewed from the air bearing surface (ABS), or from the direction indicated by line 4-4 in FIG. 3. As can be seen, in FIG. 4, the shield 338 can be a wrap-around trailing shield that provides both shielding in the trailing direction and also at the sides of the write pole. As mentioned above, the trailing shield 338 is separated from the trailing edge of the write pole 314 by a non-magnetic trailing gap layer 339. In addition, the side portions of the trailing shield 338 are separated from the sides of the write pole 314 by first and second non-magnetic side gap layers 402, 404 that can be constructed of a material such as alumina or of some other material. The side gap layers 402, 404 can be constructed to a thickness that is different than that of the trailing gap 314. The side gaps 402, 404 are preferably thicker than the trailing gap layer 314.

The side portions of the shield 338 provide magnetic shielding to prevent stray fields, such as those from the upper coils of the write coil 322 (FIG. 3) from reaching the magnetic medium 330 (FIG. 3). It should be pointed out, however, that while the shield 339 is being described herein as being a trailing, wrap-around magnetic shield, it could also be a pure trailing shield that does not include side portions that extend down the sides of the write pole 402, 404. Alternatively, the shield 338 could include only side shield portions that with no trailing shield portions. The shield 338 could even include a trailing shield portion and side shield portions that are separate from one another. These various possible configurations are considered to fall within the scope of the invention, although the embodiment described in FIG. 4 is considered to be most preferable.

While the trailing portion of the shield advantageously improves write field gradient, and the wrap-around side portions are effective for shielding fields from the write coil, prior art wrap-around trailing shield have suffered from problems that have resulted in stray magnetic fields causing unwanted wide area track erasure. When these shields have become magnetized, they have caused stray field to be emitted from areas such as at the outer corners of the shield, and these stray fields cause data erasure in data tracks several tracks away from the track being written to. One way to alleviate this problem would be to increase the throat height of the shield. However, this results in other problems, such as unacceptable levels of over-writing.

We have found that a major contributor to such wide area track erasure is due to the magnetic saturation of the wrap-around trailing magnetic shield. Therefore, according to an aspect of the present invention, the shield 338 is constructed of a low permeability (low μ) material. Previously, it was assumed that, for a trailing wrap-around shield to function effectively, it must be constructed of a material having a low magnetic coercivity. A material typically used was NiFe, because it has a low magnetic coercivity and is readily available. Because it was believed that a low coercivity material was needed for the shield, the state of the art taught away from the use of low permeability materials (low μ) because these material typically have higher coercivity.

It has been found, however, that a low permeability material can be used in the shield, to greatly reduce adjacent track interference, with little or no negative affect on write field strength or field gradient. Furthermore, the inventors have found that certain materials provide lower saturation while also having a desirably low coercivity. Such materials include CoFeCr, CoFeP, CoFeCu and CoFeB. Therefore, while the invention applies to the use of a magnetic shield 338 having a low permeability generally, the shield is preferably constructed of one of these materials, CoFeCr, CoFeP, CoFeCu and CoFeB. Most preferably, the shield 338 is constructed of CoFeB or CoFeP, as these materials have been found to exhibit the best performance overall. Also, the B or P content in the CoFeB or CoFeP shield 338 is preferably 20-35 atomic percent. Which makes amorphous and magnetically soft. If one of the other materials (CoFeCr or CoFeCu) are used they too preferably have a Cu or Cr content of around 20-35 atomic percent.

The magnetic shield 338 is preferably constructed of a material having a permeability (μ) of less than 500, and more preferably about 200 or less. It has been found that when the permeability of the shield is at or below 200, adjacent track interference is negligible.

While various embodiments have been described, it should be understood that they have been presented by way of example only, and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

What is claimed is:

1. A magnetic write head, comprising:
a magnetic write pole having an end disposed toward an air bearing surface, the magnetic write pole having first and second laterally opposed sides and a trailing edge extending from the first side to the second side;
a trailing, wrap-around magnetic shield having a portion that is separated from the trailing edge by a non-magnetic trailing gap layer and first and second side portions that are separated from the first and second sides of the write pole by first and second non-magnetic gap layers, the trailing, wrap-around magnetic shield being constructed of a magnetic material having a low magnetic permeability (low μ).

2. A magnetic write head as in claim 1 wherein the trailing, wrap-around magnetic shield comprises a material selected from the group consisting of, CoFeCr, CoFeP, CoFeCu and CoFeB.

3. A magnetic write head as in claim 1 wherein the trailing, wrap-around magnetic shield comprises CoFeX, having 20-35 atomic percent X, where X is a material selected from the group consisting of CoFeP, CoFeCu and CoFeB.

4. A magnetic write head as in claim 1 wherein the trailing, wrap-around magnetic shield comprises CoFeP or CoFeB.

5. A magnetic write head as in claim 1 wherein the trailing, wrap-around magnetic shield comprises CoFeX, having 20-35 atomic percent X, where X is P or B.

6. A magnetic write head as in claim 1 wherein the trailing, wrap-around magnetic shield comprises CoFeB.

7. A magnetic write head as in claim 1 wherein the trailing, wrap-around magnetic shield comprises CoFeB having 20-35 atomic percent B.

8. A magnetic write head as in claim 1 wherein the trailing wrap-around magnetic shield comprises CoFeP.

9. A magnetic write head as in claim 1 wherein the trailing wrap-around magnetic shield comprises CoFeP having 20-35 atomic percent P.

10. A magnetic write head, comprising:
a magnetic write pole having an end disposed toward an air bearing surface, the magnetic write pole having first and second laterally opposed sides and a trailing edge extending from the first side to the second side;
first and second magnetic side shields, extending laterally outward from the first and second sides of the write pole, the first and second being separated from the first and second sides of the write pole by first and second non-magnetic side gap layers, the first and second side shields each being constructed of a material having a low magnetic permeability (low μ).

11. A magnetic write head as in claim 10 wherein the first and second magnetic side shields each comprise a material selected from the group consisting of, CoFeCr, CoFeP, CoFeCu and CoFeB.

12. A magnetic write head as in claim 10 wherein the first and second magnetic side shields each comprise CoFeX, having 20-35 atomic percent X, where X is a material selected from the group consisting of CoFeP, CoFeCu and CoFeB.

13. A magnetic write head as in claim 10 wherein the first and second magnetic side shields each comprise CoFeP or CoFeB.

14. A magnetic write head as in claim 10 wherein the first and second magnetic side shields each comprise CoFeX, having 20-35 atomic percent X, where X is P or B.

15. A magnetic write head as in claim 10 wherein the first and second magneticside shields each comprise CoFeP.

16. A magnetic write head as in claim 10 wherein the first and second magnetic side shields each comprise CoFeP having 20-35 atomic percent P.

17. A magnetic write head as in claim 10 wherein the first and second magnetic side shields each comprise CoFeB.

18. A magnetic write head as in claim 10 wherein the first and second magnetic side shields each comprise CoFeB having 20-35 atomic percent B.

19. A magnetic write head, comprising:
a magnetic write pole having an end disposed toward an air bearing surface, the magnetic write pole having first and second laterally opposed sides and a trailing edge extending from the first side to the second side;
a trailing magnetic shield that is separated from the trailing edge of the write pole by a non-magnetic trailing gap layer, the trailing magnetic shield being constructed of a magnetic material having a low magnetic permeability (low μ).

20. A magnetic write head as in claim 19 wherein the trailing magnetic shield comprises a material selected from the group consisting of, CoFeCr, CoFeP, CoFeCu and CoFeB.

21. A magnetic write head as in claim 19 wherein the trailing magnetic shield comprises CoFeX, having 20-35 atomic percent X, where X is a material selected from the group consisting of CoFeP, CoFeCu and CoFeB.

22. A magnetic write head as in claim 19 wherein the trailing magnetic shield comprises CoFeP or CoFeB.

23. A magnetic write head as in claim 19 wherein the trailing, wrap-around magnetic shield comprises CoFeX, having 20-35 atomic percent X, where X is P or B.

24. A magnetic write head as in claim 19 wherein the trailing magnetic shield comprises CoFeB having 20-35 atomic percent B.

25. A magnetic write head as in claim 19 wherein the trailing magnetic shield comprises CoFeP having 20-35 atomic percent P.
